(19) United States
(12) Patent Application Publication
(10) Pub. No.: US 2025/0293753 A1
(43) Pub. Date: Sep. 18, 2025

(54) TRAINING METHOD

(71) Applicant: Fujitsu Limited, Kawasaki-shi (JP)

(72) Inventors: Kazuaki OISHI, Yokohama (JP); Atsuo HARA, Chikushino (JP)

(73) Assignee: Fujitsu Limited, Kawasaki-shi (JP)

(21) Appl. No.: 19/034,695

(22) Filed: Jan. 23, 2025

(30) Foreign Application Priority Data
Mar. 18, 2024 (JP) 2024-042896

(51) Int. Cl. H04B 7/06; H04B 17/309; H04W 24/02

(52) U.S. Cl. CPC H04B 7/06952; H04B 17/346; H04W 24/02

(57) ABSTRACT

A method includes: executing, for each of beams, first calculation processing of outputting setting information set for an antenna element that forms a beam, from first information for identifying a radiation shape of the beam, second calculation processing of outputting radio wave radiation shape information on a radio wave radiation shape from the setting information, an arrangement of the antenna element, and coordinates of an installation position of the antenna element, and third calculation processing of outputting received power information on a received power of each terminal apparatus from the radio wave radiation shape information of the plurality of beams and transmission path characteristics; and executing fourth calculation processing of outputting reception state information on a reception state of the beam from the received power information of each terminal apparatus, and training processing of training a first model that executes the first calculation processing by using the first information and the reception state information.

### CROSS-REFERENCE TO RELATED APPLICATION

This application is based upon and claims the benefit of priority of the prior Japanese Patent Application No. 2024-42896, filed on Mar. 18, 2024, the entire contents of which are incorporated herein by reference.

### FIELD

The embodiments discussed herein are related to a training method.

### BACKGROUND

In recent years, massive MIMO (mMIMO) has attracted attention in wireless communication. In the mMIMO, a base station apparatus includes, for example, a plurality of antenna elements. The base station apparatus performs beamforming (BF) by adjusting phases of radio waves radiated from the plurality of antenna elements to amplify radio wave intensity in a predetermined direction. In the beamforming, it is possible to improve a signal-to-noise ratio (SNR) in a predetermined direction and it is possible to increase throughput as compared with a single-antenna system.

Japanese Laid-open Patent Publication No. 2023-085217 and Japanese National Publication of International Patent Application No. 2022-527795 are disclosed as related art.

### SUMMARY

According to an aspect of the embodiments, a training method includes: executing, for each of a plurality of beams, first calculation processing of outputting setting information set for an antenna element that forms a beam, from first information for identifying a radiation shape of the beam, second calculation processing of outputting radio wave radiation shape information on a radio wave radiation shape of the antenna element from the setting information, an arrangement of the antenna element, and coordinates of an installation position of the antenna element, and third calculation processing of outputting received power information on a received power of each of a plurality of terminal apparatuses from the radio wave radiation shape information of the plurality of beams and transmission path characteristics; and executing fourth calculation processing of outputting reception state information on a reception state of the beam for each terminal apparatus from the received power information of each of the plurality of terminal apparatuses, which is output for each of the plurality of beams, and training processing of training a first model that executes the first calculation processing by using the first information and the reception state information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a wireless communication system;

FIG. 2 is a diagram illustrating a configuration example of a simulation apparatus;

FIG. 3 is a diagram illustrating an example of a software configuration in execution of BF weight NN training processing;

FIG. 4 is a diagram illustrating an example of a processing flowchart of BF weight NN training processing;

FIG. 5 is a diagram illustrating an example of a processing flowchart of radiation propagation NN and propagation loss NN training processing;

FIG. 6 is a diagram illustrating an example of a configuration of a radiation propagation NN;

FIG. 7 is a diagram illustrating an example of a processing flowchart of terminal position NN training processing; and

FIG. 8 is a diagram illustrating an example of a configuration of a terminal position NN.

### DESCRIPTION OF EMBODIMENTS

With regard to radiation patterns of the beamformed radio waves, while strong radio waves are radiated in a predetermined direction, unwanted radio waves are radiated in other directions. Consequently, interference may occur between beams transmitted to other terminal apparatuses (inter-beam interference), or the unwanted radio waves may be radiated to adjacent cells (inter-cell interference). In a wireless communication system that supports the beamforming, the phases and the gains of the radio waves radiated from the plurality of antenna elements are adjusted, and thus, radiation shapes of the radio waves may be deformed. As a result, control of suppressing the interference may be performed.

Techniques related to the beamforming are described in, for example, the following documents.

However, in the above-described control of beamforming, since there are objects such as buildings that obstruct the propagation of radio waves (reflection of radio waves, etc.) in a real space, calculation errors between ideal and non-ideal (real) radiation patterns from the plurality of antenna elements or etc. occur. Thus, it was difficult to appropriately perform setting for the antenna elements for forming beam shapes to suppress the interference and to emphasize radiation power in a desired direction . . .

Therefore, according to one disclosure, it is possible to provide a training method of a neural network capable of acquiring an appropriate setting value of an antenna element in beamforming.

### First Embodiment

A first embodiment will be described.

### About Wireless Communication System 1

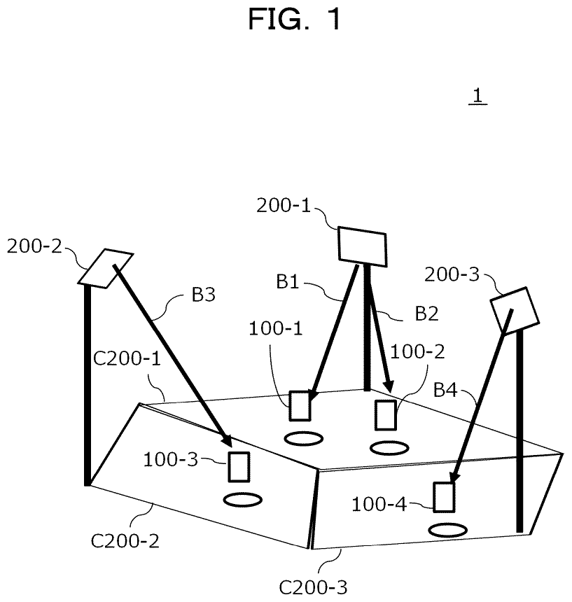

FIG. 1 is a diagram illustrating a configuration example of a wireless communication system 1. The wireless communication system 1 includes base station apparatuses 200-1 to 200-3 and terminal apparatuses 100-1 to 100-4. The wireless communication system 1 is, for example, a communication system that supports mMIMO.

The base station apparatuses 200-1 to 200-3 (hereinafter, may be referred to as base station apparatuses 200) are apparatuses that perform wireless communication with the terminal apparatuses 100-1 to 100-4 (hereinafter, may be referred to as terminal apparatuses 100), and are, for example, eNodeBs or gNodeBs. The base station apparatus 200 includes, for example, one or more antenna elements, and performs beamforming by controlling setting values for the antenna elements.

The base station apparatus 200 constitutes a communication area (cell) which is an area in which the terminal apparatus 100 performs wireless communication with the base station apparatus 200. The base station apparatuses 200-1 to 200-3 constitute cells C200-1 to C200-3, respectively. While the cells C200-1 to C200-3 do not overlap each other in FIG. 1, these cells may overlap each other.

For example, the terminal apparatuses 100-1 and 100-2 exist in the cell C200-1. The base station apparatus 200-1 transmits a beam B1 to the terminal apparatus 100-1 and transmits a beam B2 to the terminal apparatus 100-2. In this manner, one base station apparatus 200 may transmit a plurality of beams. For example, the plurality of beams may be transmitted by using antenna element groups each constituted by different antenna elements, or may be transmitted by using antenna element groups constituted by the same or partially the same antenna elements.

### Configuration Example of Simulation Apparatus 300

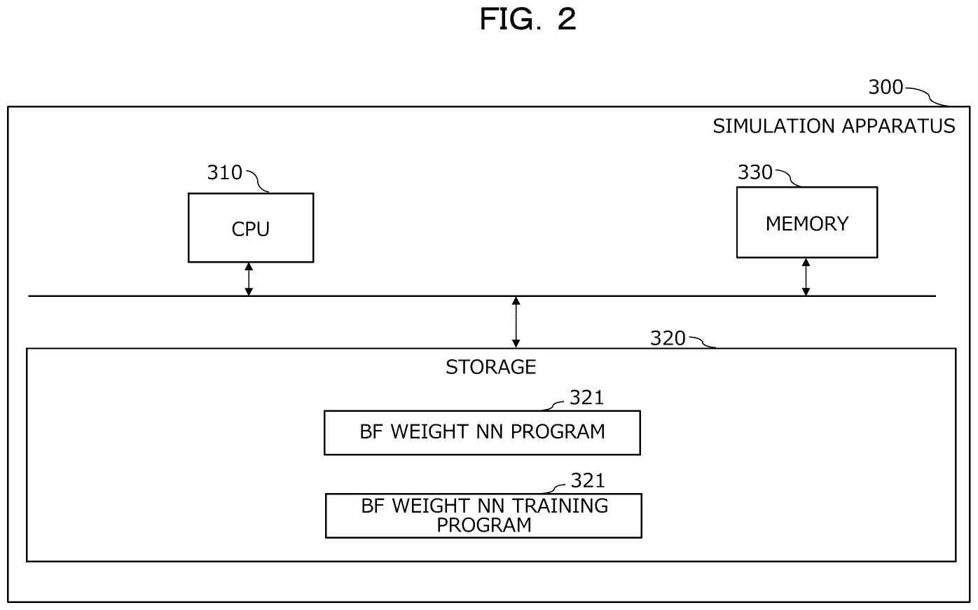

FIG. 2 is a diagram illustrating a configuration example of a simulation apparatus 300. The simulation apparatus 300 is, for example, a computer machine or a server machine, and is a simulator that trains a neural network (NN) that outputs the setting values (BF weights) of the antenna elements. The simulation apparatus 300 includes a central processing unit (CPU) 310, a storage 320, and a memory 330.

The storage 320 is an auxiliary storage device, such as a flash memory, a hard disk drive (HDD), or a solid state drive (SSD), for storing programs and data. The storage 320 stores a BF weight NN program 321 and a BF weight NN training program 322.

The memory 330 is an area into which the programs stored in the storage 320 are loaded. The memory 330 may be used as an area where the programs store data.

The CPU 310 is a processor that constructs respective units and realizes respective kinds of processing by loading the programs stored in the storage 320 into the memory 330 and executing the loaded programs.

By executing the BF weight NN program 321, the CPU 310 constructs a BF weight NN and executes BF weight calculation processing. A BF weight is a setting for the antenna element, and is, for example, a phase and a gain. The BF weight NN is an artificial intelligence (AI) that calculates the BF weight, and is, for example, an NN.

By executing the BF weight NN training program 322, the CPU 310 constructs a training unit and executes BF weight NN training processing. The BF weight NN training processing is processing of training the BF weight NN. The BF weight NN training processing includes BF weight calculation processing, radiation propagation calculation processing, BF calculation processing, propagation loss calculation processing, SINR calculation processing, and optimization processing.

### BF Weight NN Training Processing

BF weight NN training processing S100 is processing of training the BF weight NN. The BF weight NN is an artificial intelligence (AI) that calculates the BF weight when a beam ID is input, and is, for example, a neural network.

The beam ID is an identifier of a pattern (radiation pattern) related to a radiation shape of the beam, and is, for example, a number or a numeral. There are a plurality of beam IDs for each beam (for each base station apparatus). For example, the beam ID is allocated to each radiation pattern of the beam B2 in FIG. 1, and a beam ID of the beam B2 is represented as a beam B2ID. Hereinafter, a beam ID of a beam n may be referred to as a beam nID.

The beam ID corresponds to, for example, a radiation target area (a position of the terminal apparatus 100). For example, beam 1ID=1 corresponds to a certain area x, and beam 1ID=2 corresponds to a certain area y (an area different from the area x). In an actual operation, for example, the base station apparatus 200 radiates a beam corresponding to an area where the terminal apparatus 100 is located. The beam ID may be, for example, information (first information) regarding the radiation shape of the beam.

The BF weights are the setting values of the respective antenna elements that form the beam (for example, phase and gain. hereinafter, the BF weight indicates a phases and a gains). The BF weight NN calculates (outputs) the BF weights corresponding to the beam ID.

### Software Configuration Example

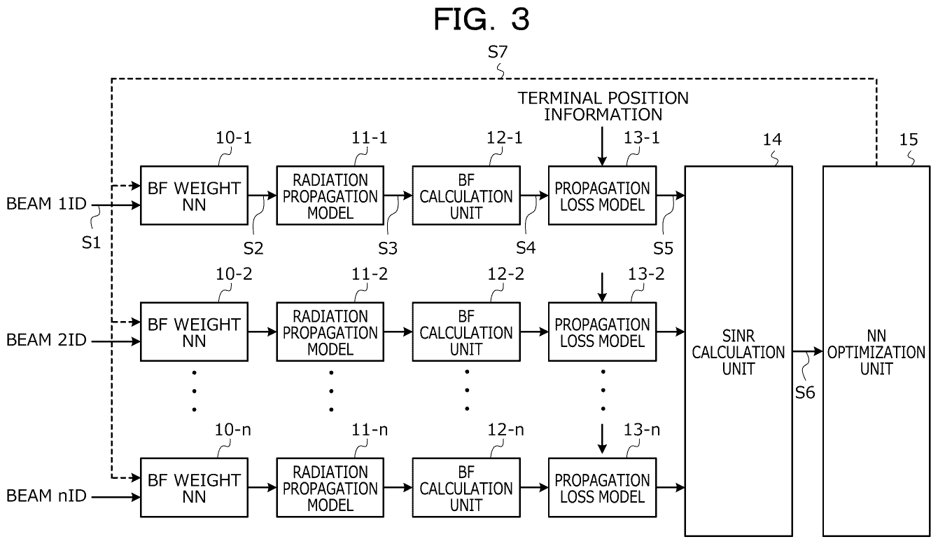

FIG. 3 is a diagram illustrating an example of a software configuration in execution of the BF weight NN training processing S100. Software of the simulation apparatus 300 includes BF weight NNs 10-1 to 10-n (n is an integer of 1 or more), radiation propagation models 11-1 to 11-n, BF calculation units 12-1 to 12-n, propagation loss models 13-1 to 13-n, an SINR calculation unit 14, and an NN optimization unit 15. n indicates, for example, a beam number.

The BF weight NNs 10-1 to 10-n (hereinafter, may be referred to as BF weight NNs 10), the radiation propagation models 11-1 to 11-n (hereinafter, may be referred to as radiation propagation models 11), the BF calculation units 12-1 to 12-n (hereinafter, may be referred to as BF calculation units 12), and the propagation loss models 13-1 to 13-n (hereinafter, may be referred to as propagation loss models 13) are provided for respective beam numbers. While each unit corresponding to the beam 1 will be described below, individual units corresponding to the beam 2 to the beam n also have similar configurations and similar inputs and outputs.

The BF weight NN 10 is an NN that calculates the BF weights of the antenna elements (for example, some or all of the antenna elements of the base station apparatus 200-1) that form the beam. When the beam ID is input (S1), the BF weight NN 10 outputs the BF weights corresponding to the beam ID (S2).

The radiation propagation model 11 is a model that calculates a radiation shape from the individual antenna elements, and executes, for example, a calculation expression prepared in advance. When the BF weights corresponding to the beam ID are input (S2), the radiation propagation model 11 calculates the radiation shape from each antenna element from information on a physical arrangement and coordinates of the antenna in consideration of an influence of a transmission path, and outputs phases and gains for each direction (angle) of radiation from each antenna element for each antenna element (S3). Output S3 is, for example, a list of angles and corresponding the phases and the gains for each antenna element.

The BF calculation unit 12 is a model that calculates a radiation shape of a beam obtained by combining radiation from each antenna element in a space, and executes, for example, a calculation expression prepared in advance. When the phase and the gain for each angle of radiation from each antenna element are input (S3), the BF calculation unit 12 calculates the radiation shape of the beam by calculating interference of radio waves radiated from the respective antenna elements, and outputs power (gain) for each direction of the beam (S4). Output S4 is, for example, a list of angles (directions) and corresponding gains.

The propagation loss model 13 is a model that calculates a propagation loss in a space from a radiation shape and a terminal position and calculates a received power in the terminal apparatus 100, and executes, for example, a calculation expression prepared in advance. When the position information of the terminal apparatus 100 and the power for each direction of the beam are input (S4), the propagation loss model 13 calculates the propagation loss and outputs the received power for each terminal apparatus 100 (S5). For example, the power of each of a desired wave and an interfering wave is output as the received power.

The number of terminal apparatuses 100 is, for example, a number corresponding to the number of beams. In a case where the number of beams is n, the number of terminal apparatuses 100 is also n. Since there is a case where one beam is frequency-divided and communication is simultaneously performed with a plurality of terminal apparatuses 100, the number of terminal apparatuses 100 may be greater than or equal to n. It is assumed that the terminal apparatus 100 is located at a position within an area corresponding to the beam ID of each beam. For example, in the case of beam 1ID=x, it is assumed that the terminal apparatus 100 which is a radiation target of the beam 1 is at a first position in a first area corresponding to beam 1ID=x. In the case of beam 2ID=y, it is assumed that the terminal apparatus 100 which is a radiation target of the beam 2 is at a second position in a second area corresponding to beam 2ID=y.

A value actually measured by the terminal apparatus 100 over an actually operated field may be used as terminal position information. The terminal position information may be created by setting a random or specific distribution in a space on the simulation.

The SINR calculation unit 14 calculates a signal to interference plus noise ratio (SINR) for each terminal apparatus 100. When the received power (for example, the desired wave and the interfering wave) of the terminal apparatus 100 corresponding to the beam ID of each beam is input (S5 and the received powers of the terminal apparatuses 100 corresponding to the beam IDs of the beams 2 to n), the SINR calculation unit calculates and outputs the SINR of each terminal apparatus 100 (S6). For example, when the position of the terminal apparatus 100-1 corresponds to beam 1ID=1 of the beam 1, the received power of the beam 1 of the terminal apparatus 100-1 is the desired wave, and the received powers from the other beams are the interfering waves. A noise component is calculated from, for example, thermal noise determined from a temperature. The SINR calculation unit 14 calculates the desired wave and the interfering wave for each terminal apparatus 100, and calculates the SINR in consideration of the noise component.

The NN optimization unit 15 updates (calculates) the weight of each NN of the BF weight NNs 10-1 to 10-n from the value of the SINR, and trains (updates) the BF weight NNs 10-1 to 10-n by using, for example, deep learning or the like. For example, the NN optimization unit 15 updates the weight of the NN such that the SINR increases. An increase in the SINR indicates that, for example, an average value of the SINRs of the respective terminal apparatuses 100 increases. For example, an additional condition may be set such that the SINRs of all the terminal apparatuses (or a predetermined number or more of terminal apparatuses) do not fall below a reference value.

### BF Weight NN Training Processing

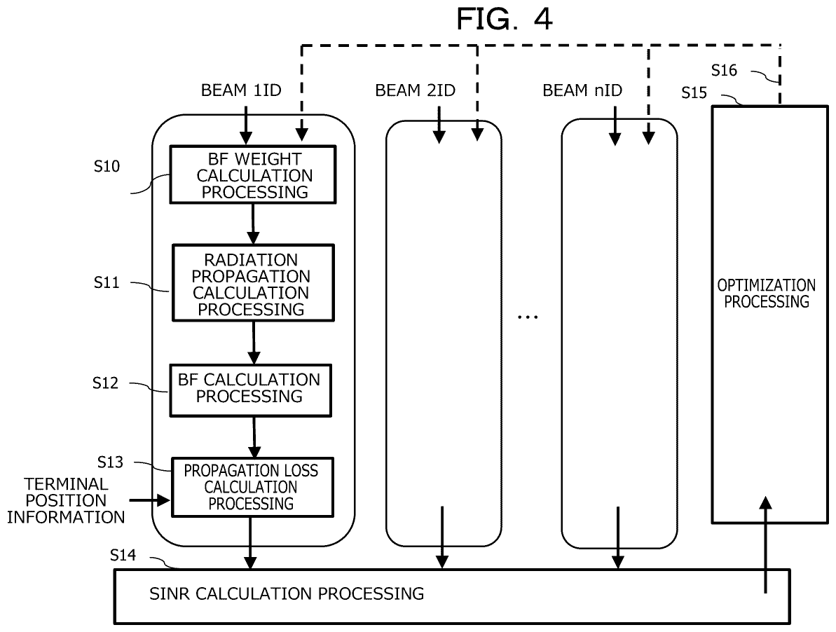

FIG. 4 is a diagram illustrating an example of a processing flowchart of the BF weight NN training processing S100. In the following description, while processing corresponding to the beam 1 will be described, the same applies to processing corresponding to the beam 2 to the beam n.

The simulation apparatus 300 receives, as an input, the beam ID, and executes BF weight calculation processing S10. The BF weight calculation processing S10 is processing executed by the BF weight NN 10 and is processing of calculating the BF weights of the antenna elements constituting the beam corresponding to the beam ID.

Subsequently, the simulation apparatus 300 receives, as inputs, the BF weights and executes radiation propagation calculation processing S11. The radiation propagation calculation processing S11 is processing executed by the radiation propagation model 11, and is processing of calculating the phase and the gain for each angle of the radiation from each antenna element.

Subsequently, the simulation apparatus 300 receives, as inputs, the phase and the gain for each angle of the radiation from each antenna element, and executes BF calculation processing S12. The BF calculation processing S12 is processing executed by the BF calculation unit 12, and is processing of calculating interference of radio waves radiated from each antenna and calculating power for each direction.

Subsequently, the simulation apparatus 300 receives, as inputs, the power for each direction of the beam and the terminal position information, and executes propagation loss calculation processing S13. The propagation loss calculation processing S13 is processing executed by the propagation loss model 13 and is processing of calculating the received power for each terminal apparatus 100 from the propagation loss.

Subsequently, the simulation apparatus 300 receives, as an input, the received power of the terminal apparatus 100 and executes SINR calculation processing S14. The SINR calculation processing S14 is processing executed by the SINR calculation unit 14 and is processing of calculating the SINR for each terminal apparatus 100.

Subsequently, the simulation apparatus 300 receives, as inputs, the SINR for each terminal apparatus 100 and executes optimization processing S15. Optimization processing S15 is processing executed by the NN optimization unit 15, and is processing of updating the weights of each NN of the BF weight NNs 10-1 to 10-n in accordance with the value of the SINR (S16).

As described above, the simulation apparatus 300 sets the position of the terminal apparatus 100 in the area corresponding to the beam ID for each beam, performs each calculation processing for each beam, calculates the SINR in consideration of the received powers from the all or neighboring beams (including the interfering waves) and the gains (including the interfering waves) of the beams with respect to all the directions, and trains the BF weight NN 10 such that the SINR increases.

The simulation apparatus 300 changes the beam ID of each beam, changes the terminal position information in the corresponding area, repeats the above-described training processing, and improves a degree of training of the BF weight NN. For example, it is assumed that the training processing is repeatedly executed until it is detected that the amount of change in the weight of the BF weight NN decreases, the amount of change in the BF weight output by the BF weight NN decreases, or the like. The number of repetitions or the like may be determined in advance.

### Reflection in Actual Operation

For example, the base station apparatus 200 in FIG. 1 stores the trained BF weight NN. In an actual operation, the base station apparatus 200 selects the beam ID corresponding to the position of the terminal apparatus 100, inputs the beam ID to the trained BF weight NN, acquires the BF weight, and controls the antenna element. Instead of the trained BF weight NN, the base station apparatus 200 may store, as data, a list of beam IDs and corresponding BF weights output by using the trained BF weight NN.

### Modification Example

While the weight is updated in accordance with the SINR, for example, the BF weight NN 10 may consider a transmission power of the base station apparatus 200. The simulation apparatus 300 calculates the transmission power of the base station apparatus 200 from the gain of the BF weight, and outputs the transmission power to the NN optimization unit 15. The NN optimization unit 15 updates the weight of the NN in consideration of both of the transmission power and the SINR. For example, the NN optimization unit 15 updates the weight of the NN such that an average value of the transmission powers is as small as possible and an average value of the SINRs is as large as possible.

One or more beam IDs of one or more other beams may also be simultaneously input as the information input to the BF weight NN 10. In this case, the trained BF weight NN 10 uses, as input information, the beam ID of the beam and the beam IDs of the other beams, and outputs the BF weight of the beam.

Information (numerical value) on another communication state may be used instead of the SINR. For example, throughput may be used at the time of optimization instead of or in addition to the SINR. The SINR is an example of a numerical value indicating the communication state, and an index other than the SINR may be used as long as the index indicates the communication state.

### Second Embodiment

Next, a second embodiment will be described. In the second embodiment, a simulation apparatus 300 causes an AI to execute radiation propagation calculation processing and propagation loss calculation processing. The simulation apparatus 300 trains each of a radiation propagation NN that performs the radiation propagation calculation processing and a propagation loss NN that performs the propagation loss calculation processing. Each of the radiation propagation NN and the propagation loss NN is, for example, a neural network. The radiation propagation NN and the propagation loss NN are constructed by, for example, a CPU 310 included in the simulation apparatus 300 executing a stored program.

### Radiation Propagation NN and Propagation Loss NN Training Processing

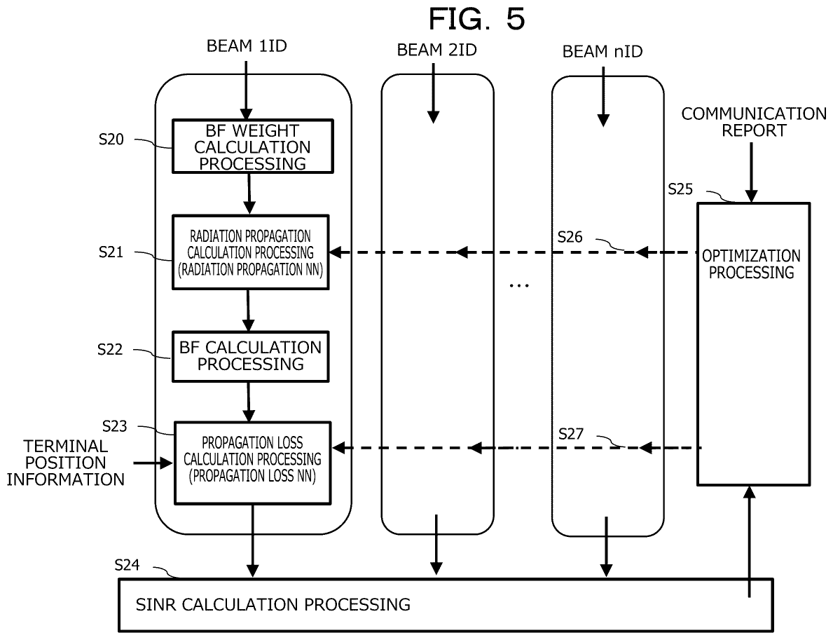

FIG. 5 is a diagram illustrating an example of a processing flowchart of the radiation propagation NN and propagation loss NN training processing S200. In the following description, while processing corresponding to the beam 1 will be described, the same applies to processing corresponding to the beam 2 to the beam n.

The simulation apparatus 300 receives, as inputs, the beam ID, and executes BF weight calculation processing S20. In the first embodiment, the BF weight processing S10 is executed by the BF weight NN. The BF weight calculation processing S20 may be executed by the trained BF weight NN in the first embodiment, or may be executed by another NN or model (processing unit that calculates a predetermined expression).

Subsequently, the simulation apparatus 300 receives, as an input, the BF weight and executes radiation propagation calculation processing S21. The radiation propagation calculation processing S21 is executed by the radiation propagation NN.

Subsequently, the simulation apparatus 300 receives, as inputs, phases and gains for each angle of radiation from each antenna element, and executes BF calculation processing S22. The BF calculation processing S22 is similar to, for example, the BF calculation processing S12 in the first embodiment.

Subsequently, the simulation apparatus 300 receives, as inputs, power for each direction of the beam and terminal position information, and executes propagation loss calculation processing S23. The propagation loss calculation processing S23 is processing executed by the propagation loss NN.

Subsequently, the simulation apparatus 300 receives, as an input, a received power of the terminal apparatus 100 and executes SINR calculation processing S24. The SINR calculation processing S24 is similar to, for example, the SINR calculation processing S14 in the first embodiment.

Subsequently, the simulation apparatus 300 receives, as inputs, the SINR for each terminal apparatus 100 and executes optimization processing S25. The optimization processing S25 uses, for example, a communication report from the terminal apparatus 100. The communication report is, for example, an actually measured value for the terminal apparatus 100 and includes a received power and an SINR. In optimization processing S25, the simulation apparatus 300 updates the weights of the NNs in the radiation propagation NN and the propagation loss NN and trains the radiation propagation NN and the propagation loss NN such that a difference between the received power and the SINR actually measured by the terminal apparatus 100 and the received power and the SINR calculated by each calculation processing decreases (becomes 0) in accordance with the difference (S26 and S27).

The simulation apparatus 300 changes the beam ID of each beam, changes the terminal position information in the corresponding area, repeats the above-described training processing, and improves a degree of training of the radiation propagation NN and the propagation loss NN.

### Radiation Propagation NN Configuration Example

The radiation propagation NN may be constructed by, for example, one neural network or a combination of one or more neural networks and a circuit.

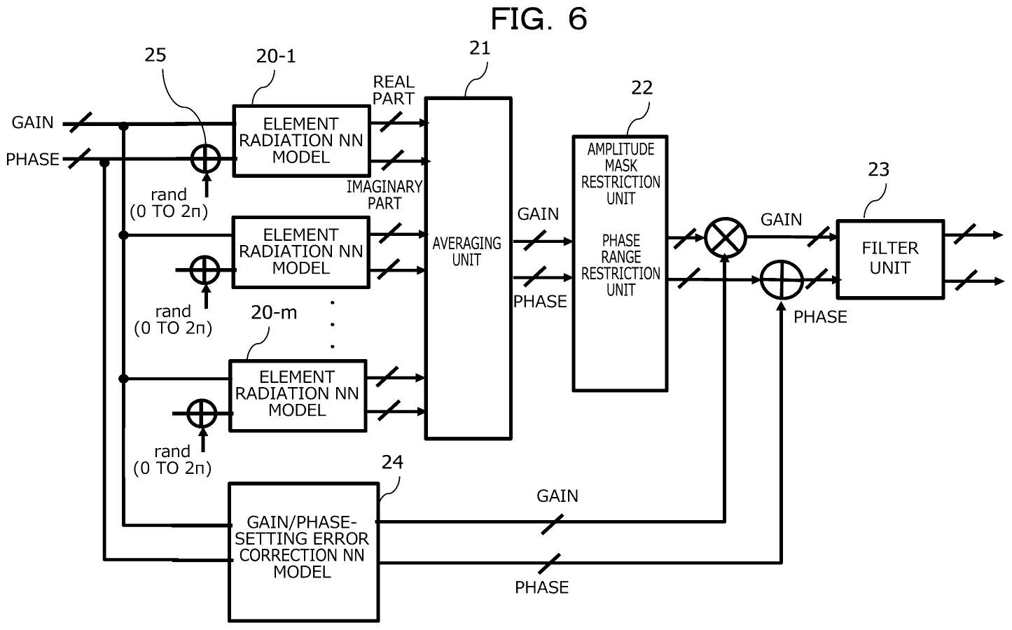

FIG. 6 is a diagram illustrating an example of a configuration of the radiation propagation NN. The radiation propagation NN includes element radiation NN models 20-1 to 20-m (m is an integer of 1 or more. Hereinafter, may be referred to as element radiation NN models 20), a random circuit 25, an averaging unit 21, an amplitude mask restriction unit and phase range restriction unit 22, a filter unit 23, and a gain/phase-setting error correction NN model 24.

The element radiation NN model 20 includes an NN related to all the antenna elements, and calculates, for example, a radiation shape. For example, from actually measured values of the SINR and/or the received power of the terminal apparatus 100, the element radiation NN model 20 estimates and outputs a radiation shape (for example, a gain and a phase of a radiated electric wave for each direction) of each antenna element corresponding to the BF weight of each antenna element. The element radiation NN model 20 adds a random phase to the phase via the random circuit 25, and uses the phase. The random phase is added, and thus, the element radiation NN model 20 may be trained without correlation.

For example, the averaging unit 21 averages outputs from the element radiation NN model 20 of each antenna element. The averaging is performed, and thus, it is possible to suppress deviation of an estimation result. In a case where there is only one element radiation NN model 20, the averaging unit 21 may not be installed.

The amplitude mask restriction unit and phase range restriction unit 22, for example, restricts a protruding amplitude to a predetermined value or less and restricts a protruding phase within a predetermined range.

The gain/phase-setting error correction NN model 24 is, for example, a model that receives, as inputs, setting values of the gain and the phase for the antenna element and outputs an error between the setting value and an actual output value of the antenna element. The gain/phase-setting error correction NN model 24 is a model that estimates and is trained on the error between the setting value of the antenna element and the actual output value such that an error between the received power/the SINR calculated from the setting value of the antenna element and the received power/the SINR actually measured by the terminal apparatus decreases. The error is output, and thus, an individual difference of the antenna element or/and the base station apparatus 200 may be absorbed.

In a case where there is a steep change in the output of the amplitude mask restriction unit and phase range restriction unit 22, since the optimization is hindered, the filter unit 23 is included for the purpose of smoothing.

As described above, the NN that is trained on the radiation shape for each antenna element and trained on the error of the setting value is installed, and thus, it is possible to construct the radiation propagation NN.

The filter unit 23, the amplitude mask restriction unit and phase range restriction unit 22, and the random circuit 25 may not be installed in some cases depending on individual differences of the antenna elements, manufacturing accuracy of the antenna (base station apparatus 200), or the like.

### Third Embodiment

A third embodiment will be described. In the third embodiment, a simulation apparatus 300 causes an AI to execute estimation of terminal position information. The simulation apparatus 300 trains a terminal position NN. The terminal position NN is an NN that estimates the terminal position information. The terminal position NN is constructed by, for example, a CPU 310 included in the simulation apparatus 300 executing a stored program.

### Terminal Position NN Training Processing

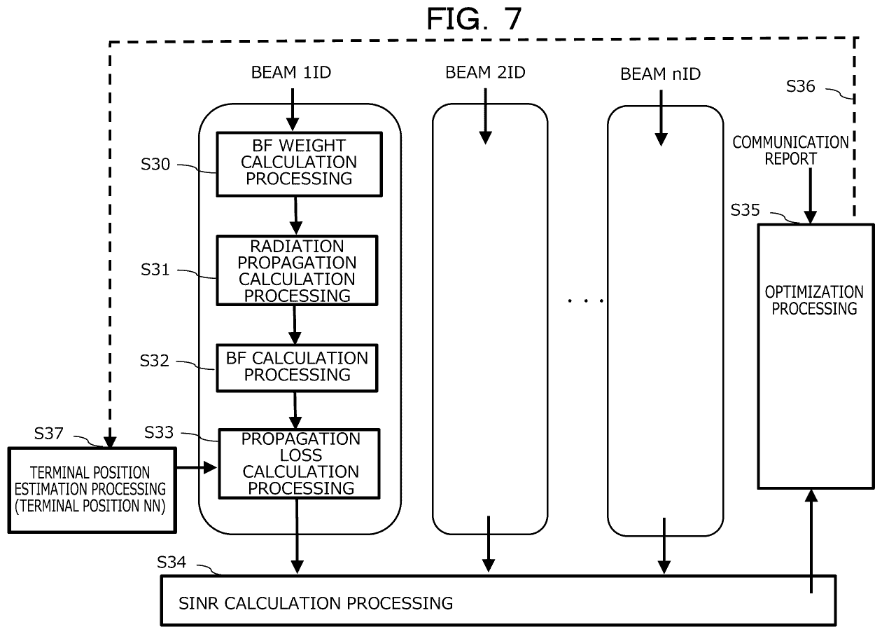

FIG. 7 is a diagram illustrating an example of a processing flowchart of terminal position NN training processing S300. In the following description, while processing corresponding to the beam 1 will be described, the same applies to processing corresponding to the beam 2 to the beam n.

The simulation apparatus 300 receives, as an input, a beam ID, and executes BF weight calculation processing S30. The BF weight calculation processing S30 is similar to, for example, the BF weight calculation processing S20 in the second embodiment.

Subsequently, the simulation apparatus 300 receives, as an input, the BF weight and executes radiation propagation calculation processing S31. The radiation propagation calculation processing S31 is similar to, for example, the radiation propagation calculation processing S11 in the first embodiment.

Subsequently, the simulation apparatus 300 receives, as inputs, phases and the gains for each angle of radiation from antenna elements, and executes BF calculation processing S32. The BF calculation processing S32 is similar to, for example, the BF calculation processing S12 in the first embodiment.

Subsequently, the simulation apparatus 300 receives, as inputs, power for each direction of the beam and terminal position information, and executes propagation loss calculation processing S33. The propagation loss calculation processing S33 is similar to, for example, the propagation loss calculation processing S13 in the first embodiment.

In the propagation loss calculation processing S33, the terminal position information is input. The terminal position information is estimation information, and is calculated in terminal position estimation processing S37 executed by the terminal position NN.

Subsequently, the simulation apparatus 300 receives, as an input, the received power of the terminal apparatus 100 and executes SINR calculation processing S34. The SINR calculation processing S34 is similar to, for example, the SINR calculation processing S14 in the first embodiment.

Subsequently, the simulation apparatus 300 receives, as inputs, the SINR for each terminal apparatus 100 and executes optimization processing S35. The optimization processing S35 uses, for example, a communication report from the terminal apparatus 100. The communication report is, for example, an actually measured value for the terminal apparatus 100 and includes a received power and an SINR. In the optimization processing S35, the simulation apparatus 300 updates the weight of the terminal position NN such that a difference between an SINR actually measured by the terminal apparatus 100 and an SINR calculated by each calculation processing decreases (becomes 0) in accordance with the difference and trains the terminal position NN (S36).

The simulation apparatus 300 changes the beam ID of each beam, repeats the above-described training processing, and improves a degree of training of the terminal position NN.

### Terminal Position NN Configuration Example

The terminal position NN may be constituted by, for example, one neural network or a combination of one or more neural networks and a circuit.

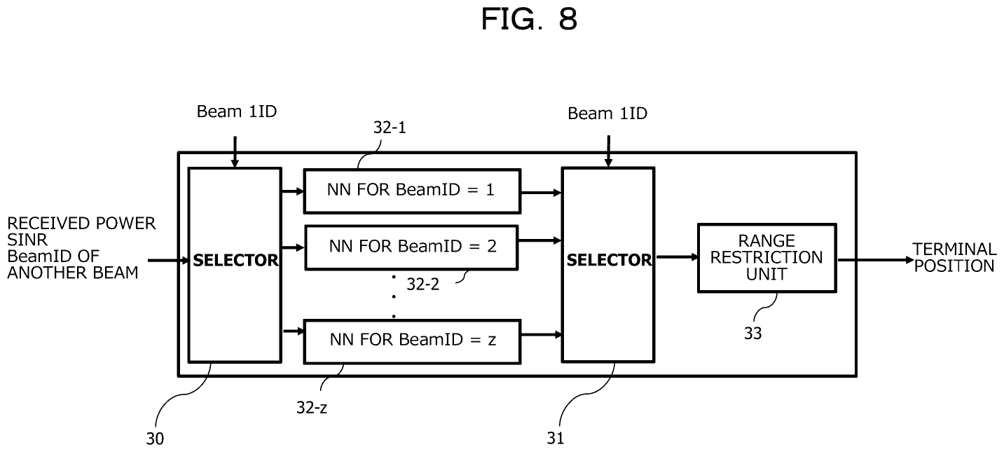

FIG. 8 is a diagram illustrating an example of a configuration of the terminal position NN. The terminal position NN includes selectors 30 and 31, beam ID NNs 32-1 to 32-z (z is the number of beam IDs and may be hereinafter referred to as beam ID NNs 32), and a range restriction unit 33.

The selectors 30 and 31 select a beam ID NN 32 for each beam ID. For example, in the case of beam ID=1, the beam ID NN for beam ID=1 is selected. In a case where there is one beam ID NN 32, the selectors 30 and 31 may not be installed.

The beam ID NN 32 outputs a position (estimated position of the terminal apparatus) corresponding to the beam ID. The beam ID NN 32 is provided for each beam ID, receives, as inputs, a received power, an SINR, and a beam ID of another beam, and outputs the estimated position of the terminal apparatus. The received power, the SINR, and the beam ID of the other beam are examples of input data, and the input data may be a part of the data or may include another data.

The range restriction unit 33 restricts the output position information within a predetermined range. Processing for excluding a protruding abnormal range and improving accuracy is performed.

### Other Embodiments

The first to third embodiments may be combined with each other in a training stage and an actual operation. The trained NN may be stored in the base station apparatus 200 in the actual operation, or results output from the trained NN may be listed and stored in the base station apparatus. The training of the NN may be executed during the actual operation.

For example, the BF weight NN training processing and the radiation propagation NN and propagation loss NN training processing may be simultaneously executed.

For example, the radiation propagation NN and propagation loss NN training processing and the terminal position NN training processing may be executed simultaneously, or may be alternately repeated and trained.

For example, in the BF weight NN training processing, the trained radiation propagation NN and propagation loss NN may be used.

For example, for the terminal apparatus 100 of which the terminal position is unknown in the actual operation, the position of the terminal apparatus 100 may be estimated by using the trained terminal position NN.

For example, in the actual operation, the training processing of the BF weight NN, the radiation propagation NN, the propagation loss NN, and the terminal position NN may be executed. In this case, the training of one type of NN or simultaneous training of a plurality of types of NNs may be executed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A training method, comprising:
executing, for each of a plurality of beams,
first calculation processing of outputting setting information set for an antenna element that forms a beam, from first information for identifying a radiation shape of the beam,
second calculation processing of outputting radio wave radiation shape information on a radio wave radiation shape of the antenna element from the setting information, an arrangement of the antenna element, and coordinates of an installation position of the antenna element, and
third calculation processing of outputting received power information on a received power of each of a plurality of terminal apparatuses from the radio wave radiation shape information of the plurality of beams and transmission path characteristics; and
executing
fourth calculation processing of outputting reception state information on a reception state of the beam for each terminal apparatus from the received power information of each of the plurality of terminal apparatuses, which is output for each of the plurality of beams, and
training processing of training a first model that executes the first calculation processing by using the first information and the reception state information.

2. The training method according to claim 1, wherein
the first model includes one or more neural networks, and
in the training processing, weights of coupling in the one or more neural networks are optimized.

3. The training method according to according to claim 2, wherein
in the training processing, the weight of the coupling is updated such that the reception state of the beam for each of the plurality of terminal apparatuses becomes favorable.

4. The training method according to claim 1, wherein
the setting information includes a phase and a gain set for the antenna element.

5. The training method according to claim 2, wherein
the radiation shape of each of the plurality of beams corresponds to each of areas, and the plurality of terminal apparatuses are located in the respective areas,
in the third calculation processing, the received power of each of the plurality of terminal apparatuses is calculated by using terminal position information, on positions of the plurality of terminal apparatuses, that corresponds to the radiation shape of each of the plurality of beams,
in the fourth calculation processing, received powers of a desired wave and an interfering wave in each of the plurality of terminal apparatuses are acquired from the received power of each of the plurality of terminal apparatuses arrived from the plurality of beams, and a signal to interference plus noise ratio (SINR) of each of the plurality of terminal apparatuses is calculated as the reception state, and
in the training processing, the weights of the coupling are updated such that the SINR for each of the plurality of terminal apparatuses increases.

6. The training method according to claim 5, wherein
the reception state further includes a transmission power of the antenna element, and
in the training processing, the weights of the coupling are updated in accordance with the SINR and the transmission power for each of the plurality of terminal apparatuses.

7. The training method according to claim 1, wherein
the second calculation processing is executed by a second model, and
the second model is a trained model trained by using a received power and an SINR actually measured by the terminal apparatus.

8. The training method according to claim 7, wherein
the second model includes one or more element radiation models,
the element radiation model is a model that estimates the radiation shape of the antenna element from actually measured values of the SINR and/or the received power, and
in a case where there are a plurality of the element radiation models, an averaging unit that obtains an average value of outputs of the plurality of element radiation models, and uses the average value as the radiation shape of the antenna element is installed.

9. The training method according to claim 8, wherein
in the second model, a phase random circuit that randomizes a phase is installed in an input unit of the element radiation model.

10. The training method according to claim 7, wherein
the second model includes a gain phase setting error correction model, and
the gain phase setting error correction model is a model that receives, as inputs, setting values of a gain and a phase for the antenna element and outputs an error between the setting values and actual output values of the antenna element.

11. The training method according to claim 8, wherein
the second model includes an amplitude mask restriction unit and a phase range restriction unit,
the amplitude mask restriction unit restricts a gain of an output of the radiation shape of the antenna element within a predetermined range, and
the phase range restriction unit restricts a phase of the output of the radiation shape of the antenna element within a predetermined range.

12. The training method according to claim 7, wherein
the second model includes a filter unit in an output unit, and
the filter unit smooths an output in a case where there is a steep value of a predetermined value or more.

13. The training method according to claim 1, wherein
the third calculation processing is executed by a third model, and
in the training processing, the third model further executes training related to the propagation characteristics by using a calculated reception state calculated for each of the plurality of terminal apparatuses and an actually measured reception state actually measured by each of the terminal apparatuses.

14. The training method according to claim 7, wherein
the third calculation processing is executed by a third model, and
the third model executes training related to estimation of the plurality of terminal apparatuses by using the first information and the reception state information.

15. The training method according to claim 13, wherein
the third model includes at least ono beam ID model, and
the beam ID model outputs an estimated position of the terminal apparatus that corresponds to the first information.

16. The training method according to claim 15, wherein
the third model includes a selector coupled to the beam ID model, and
the selector selects the beam ID model from among a plurality of the beam ID models in a case where the plurality of beam ID models are installed.

17. The training method according to claim 15, wherein
the third model includes a range restriction unit in a subsequent portion of the beam ID model, and
the range restriction unit restricts an output of the beam ID model within a predetermined range.
